(19) United States
(12) Patent Application Publication
(10) Pub. No.: US 2006/0190820 A1
(43) Pub. Date: Aug. 24, 2006

(54) Techniques for multi-lingual data processing

(75) Inventors: Daniel Chang, Medford, MA (US); Gabriel Rodriguez, Medford, MA (US)

Correspondence Address: HAMILTON, BROOK, SMITH & REYNOLDS, P.C., 530 VIRGINIA ROAD, P.O. BOX 9133, CONCORD, MA, 01742-9133, US

(73) Assignee: MistSoft Corporation, Waltham, MA (US)

(21) Appl. No.: 11/065,424

(22) Filed: Feb. 24, 2005

(51) Int. Cl. G06F 15/00

(52) U.S. Cl. 715/536

(57) ABSTRACT

A method and system for providing a multi-lingual user interface such as to collect responses to questionnaires. The method consists of first defining a meta level specification for the interface (typically as one or more database entries) wherein the meta level specification includes a language specifier, one or more page specifications, and an optional designator for where to user store responses. The page specifications define the textual content of a visual page as objects within the page, and also define branching logic which controls transitions between pages in response to user inputs. The textual objects may include language-dependent specifications for where to render the text on the page, and at what size. In a preferred embodiment, the meta specification is defined as a database object. The textual objects can also specify attributes for the text as rendered on the visual page. In turn, the attributes may be a size or position of the text, the values of which depend on the language specified.

### BACKGROUND OF THE INVENTION

In the majority of today's healthcare environments, the record keeping staff are the resources that patients encounter most at the time of a visit. Efficient workflow and accurate record keeping are thus well known to be necessary components of providing high quality patient care.

Although medical staff spend much of their working day caring for patients, they too spend much time filling out forms and questionnaires. Their efforts at working more productively are constantly hampered by complex, manual, paper-based data collection and distribution systems.

This process is further exascerbated in environments where patients are not fluent in the same language as most of the caregivers. This situation is common in countries such as the United States that have a large immigrant population, as well as in large cities around the world.

The increasingly global nature of commerce has also increased demand for computer hardware and software that can be used to provide common services a wide variety of people from different ethnic backgrounds and nationalities. Software providers are now typically required to modifying existing products to accommodate a large number of foreign languages. Existing methods of translating or localizing computer programs usually involves direct revision of software code. For example, after a software application has been tested and approved in an original language, such as English, the input/output text portions in the source code are translated to a target language, such as Spanish. The source code is then recompiled and linked to create a new executable file. An application program compiled in this manner is thus limited to serving users in the particular target language only.

Thus, a need exists for data processing systems having a multi-lingual capability such that they may be operated in one or more target languages as well as a source language thereby allowing for ease in localization.

Some have recognized this general problem such as U.S. Pat. No. 6,092,036 issued to Hamann and assigned to Davox Corporation. That patent describes a multi lingual data processing system that incorporates a translation system. The system operates by identifying a target language into which text associated is to be translated and a text translation table, corresponding to target language translations. The executing software can thus obtain language text from the text translation table corresponding to the target language as it operates, thus permitting a given executable file to support multiple language user interfaces.

U.S. Pat. No. 6,370,498 issued to Flores describes another multi-lingual technique. Here the methodology is to create a database that stores the text of works and multiple translations thereof in a variety of formats. The system permits a user to create and retrieve multiple translations of a work and/or translations. Via a database query, a user may choose to have a document displayed in two separate languages or in text in one language and in audio in a second language.

Of further interest is U.S. Patent Publication Number 2002/0188896 to Filteau, et al., as it describes a technique for report generation that has specific use in a medical records setting. The system generates reports that enable a physician to automatically generate diagnostic reports in a language other than the language used in the various menus and graphical user interfaces (GUIs) of the application software. A primary application language (PAL) can be the local language and represents a default reporting language. A secondary reporting language (SRL) database may have a plurality of records that indicate a diagnostic finding identifier, a language code diagnostic finding set identifier and a text field. The SRL database may be a relational database. When a reporting physician selectively desires to generate a diagnostic report in the French language, for example, the medical report generator may be configured to present a GUI that offers a specific finding identifier. The text entered in the diagnostic report will then be reflected in the associated report text field in the desired output language.

U.S. Pat. No. 6,396,515 issued to Hetherington also describes a technique to facilitate dynamic language switching in a data processing system. Software is implemented with user interface text such as menu and button labels, dialog messages, help text and the like. These language-specific component definitions are separated from underlining functionality definitions. Thus for example, label and other text base perimeters for a Java method are taken from storage objects separate from the constructor invoking the corresponding Java method. Since Java is dynamically linked at run time, one or more language specific files containing all user interface text for an application can thus be dynamically selected when an application runs.

### SUMMARY OF THE INVENTION

The present invention is a method and system for providing a multi-lingual user interface to a software application. The method consists of first defining a metadata specification for the interface (typically as one or more database entries) wherein the metadata specification includes a language specifier, one or more page specifications, page branching logic, and an optional designator for where to store user responses.

The page specification defines the graphical and textual content of a visual page as visual objects within the page. The branching logic controls transitions between visual pages in response to user inputs. The visual objects may include language-dependent specifications for where to render the object on the page, and at what size, for example.

In a preferred embodiment, the meta specification is defined as a database object.

The visual objects can be text field that not only specify the words themselves, but also other attributes for the text as rendered on the visual page. The attributes may be a font size and position of the text, the values of which depend on the language specifier.

Pages can thus be dynamically rendered by interpreting the meta specification. So, for example, a user may dynamically specify a language in which the page is to be rendered.

User responses can also be stored as database entries that are independent of the language specifier.

### BRIEF DESCRIPTION OF THE DRAWINGS

The foregoing and other objects, features and advantages of the invention will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

FIG. 1 is a high level diagram of a data processing environment in which the invention may be used.

FIG. 2 is a high level process flow of Metadata Specification Generator and Metadata Reader processes.

FIG. 3 is a diagram showing the hierarchy of components of a Meta-Specification.

FIG. 4 is an exemplary paper form used in a patient care setting.

FIG. 5 is a visual representation of an object level element.

FIGS. 6, 7, 8 and 9 illustrate other visual representations of objects.

FIG. 10 is a more detailed view of a Meta-Specification.

FIG. 11 is an App table.

FIG. 12 is an App-Page table.

FIG. 13 is an App-Language table.

FIG. 14 is an App-Page-Help table.

FIG. 15 is an App-Page-Object table.

FIG. 16 is an App-Page-Object-Pos table.

FIG. 17 is an App-Page-Object-Dictionary table.

FIG. 18 is a process flow for the Meta-Specification Reader.

FIG. 19A illustrates an EXIT flow.

FIG. 19B illustrates a HELP flow.

FIG. 20 illustrates a NEXT flow.

FIG. 21 illustrates a BACK flow.

FIG. 22 illustrates a CHANGE LANGUAGE flow.

### DETAILED DESCRIPTION OF A PREFERRED EMBODIMENT

I. High Level Overview of System Components

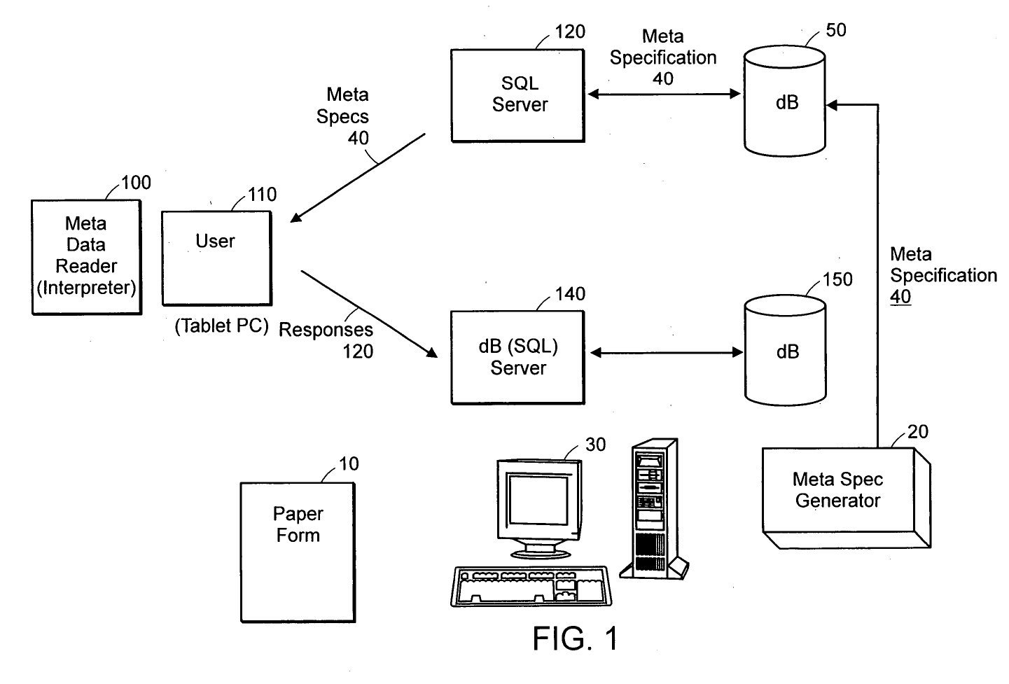

Turning attention to FIG. 1, one possible data processing environment that may incorporate the invention will be described. In general, a paper form 10 is identified for inclusion in the system as an electronic form. The electronic form will then be used to collect data, such as from a medical patient.

Core components of the system include a Metadata Specification Generator 20 and a Metadata Reader 100 software program. The Metadata Specification Generator is used to define an electronic version of the paper form 10, as one or more Meta-Specifications 40. The Metadata Reader 100 is then used to display the electronic forms as defined by one or more Meta-Specifications 40. Through the use of the Metadata Reader 100, it is also possible to produce customized multilingual versions thereof for different end users. Meta-Specifications 40 are also used for managing the evolution of applications and expressing general constraints on integrity and consistency of an application.

More particularly, a human being, serving as a form designer, first uses a Meta Specification Generator 20 program running on a data processing machine such as a Personal Computer (PC) 30 to generate one or more Meta-Specification 40 for the form 10. The Meta-Specifications 40 are then stored in a Meta-Specification database 50. As will be understood below, the Meta-Specifications 40 may embodied as a set of form specifications in Structured Query Language (SQL), Extended Markup Language (XML), a binary component (DLL) or other machine readable format.

A user of the system, such as a medical patient being examined for possible breast cancer risk, then uses the Metadata Reader 100 running on a client device such as a tablet PC 110. The Metadata Reader 100 accesses one or more Meta-Specification(s) 40 such as via a SQL server 120 connected to tablet PC 100 over a wireless local area network (WLAN). Response data 120 provided by the user is then stored in database 150 which may also be accessible by data base server 140.

It should be understood that this data processing environment is meant as only one example and that many other configurations and implementations are possible. For example, the data bases 120, 140 may be consolidated into one database structure, the data processing machines 30, 110, 120, 140 may all be the same physical machine, and other types of networks or interconnections may be used, such as wide area networks, the Internet, and so on, to connect the data processing machines.

II. Building Electronic Forms Through Meta-Specifications

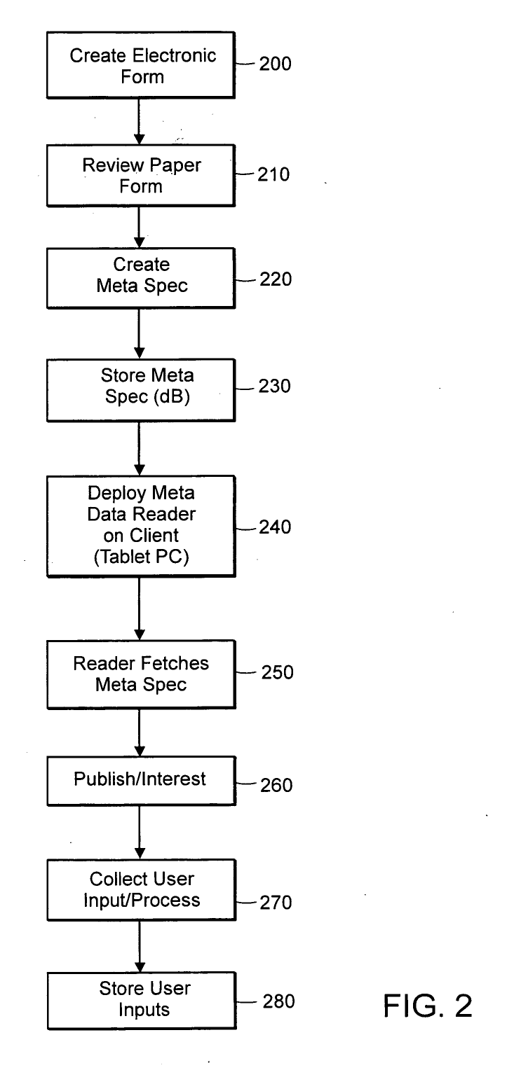

A number of steps are performed in the life cycle of an electronic form which is created and managed according to the present invention. FIG. 2 is a high level overview of this sequence of operations.

Create Electronic Forms—The first objective is to transform existing unilingual paper (analog) questionnaires into multilingual electronic (digital) questionnaires. The first step 210 in this process is to review the existing paper questionnaire from a customer. Then, in step 220 the questionnaire is transformed, typically by a software engineer, into Meta-Specifications 40 that will serve as input to the Metadata Reader 100. Multilingual capabilities are typically added to the application at this point, through further development of the Meta-Specifications 40.

Manage Electronic Forms (View, Edit, etc.)—The Meta-Specifications 40 for the form application are then stored in database 50, in step 230. (In one embodiment, this is Microsoft® SQL Server 2000, however this can be any relational database). Once these Meta-Specifications 40 are stored in the database 50, they can be retrieved for easy viewing, and editing. Any changes to the Meta-Specifications 40 will also cause the Metadata Reader 100 to change the behavior of the form application.

Deploy Electronic Forms—Once satisfied that the Meta-Specifications 40 accurately describe the multilingual electronic (digital) questionnaire, these specifications can be deployed and then “published” in step 240. Deploying typically involves making them available to client Personal Computer's (PCs) 110 for data collection purposes within the survey population. In this sense, “deploying” means that the Metadata Reader 100 software program, running on the client PC(s) 110 will be instructed to use the Meta-Specifications 40 “published” as its input.

III. Metadata Reader 100 Interprets Meta-Specifications 40

Data Collection—During this phase, in step 250 the Metadata Reader 100 fetches a Meta Specification 40 reads as its input and publishes it, i.e., produces a visual rendering of a multi-lingual, paperless, self interview questionnaire software system in step 260. This questionnaire is tailored to the question set (as well as the languages) requested by the customers, and described by the Meta-Specifications 40. User inputs are then collected in step 270.

Data Processing—At this phase the Metadata Reader 100 can also be instructed, through the Meta-Specifications, on how to process any information collected from the survey population. For example, calculations can be performed depending on different question/answer combinations. Thus step 270 can include further processing of user inputs.

Data Storing—Finally, the Metadata Reader 100 can also be instructed, through the Meta-Specifications 40, on how to store the information collected from the survey population, as in step 280. Once the information is collected and processed, it is also encoded to facilitate multilingual data retrieval.

IV. Details of Meta-Specifications 40

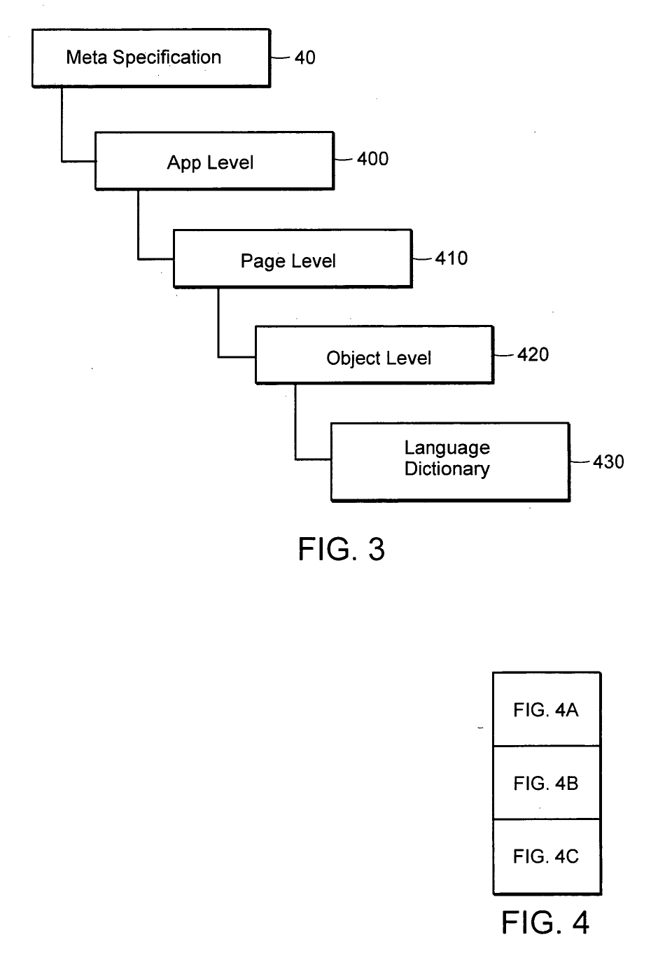

Meta-Specifications 40 are comprised of different hierarchical levels as shown in FIG. 3—including at least applications 400, pages 410 contained within these applications, objects 420 contained within these pages, and associated dictionaries 430.

Application-Level Meta-Specifications 400 describe general details pertaining to the entire application. For example: where this application stores the data (database and table name), what languages is this application available in, name of this application, and the pages contained within this application (questions along with associated help text).

Page-Level Meta-Specifications 410 describe general details pertaining to the pages that are contained within a particular application. For example: textual contents of the page, objects contained within this page, and the branching logic and business logic of the particular page (forward and reverse).

Object-Level Meta-Specifications 420 describe general details pertaining to the objects (widgets—i.e. buttons, captions, labels, etc.) that are contained within a particular page. For example: sizing of buttons, captions, labels. and any validation logic and business logic of the particular object.

Language Dictionaries 430 may include language-specific object positioning (top, left, bottom, right), any language-specific text that needs to be displayed on these objects,

As will be understood shortly, Meta-Specifications 40 also include intersections between these objects.

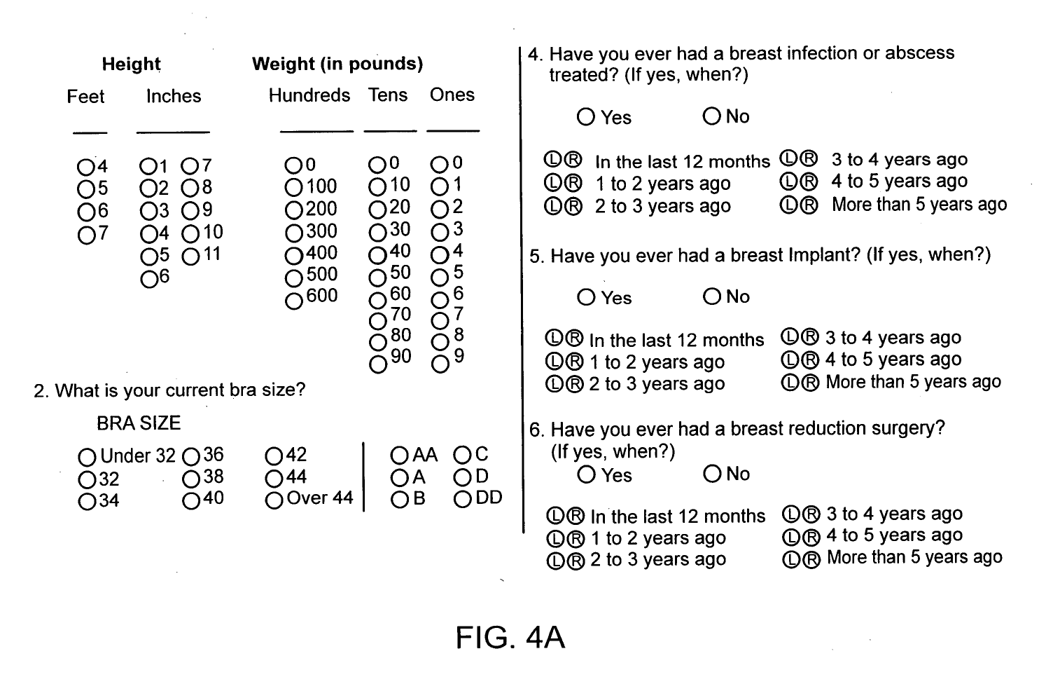

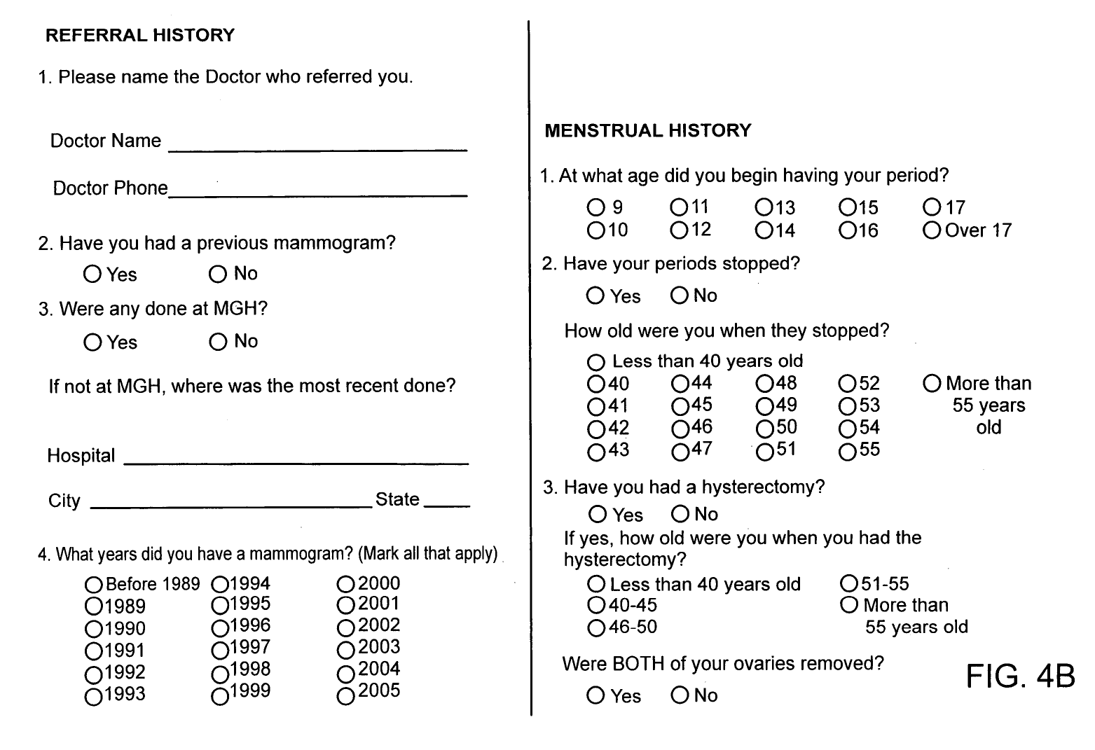

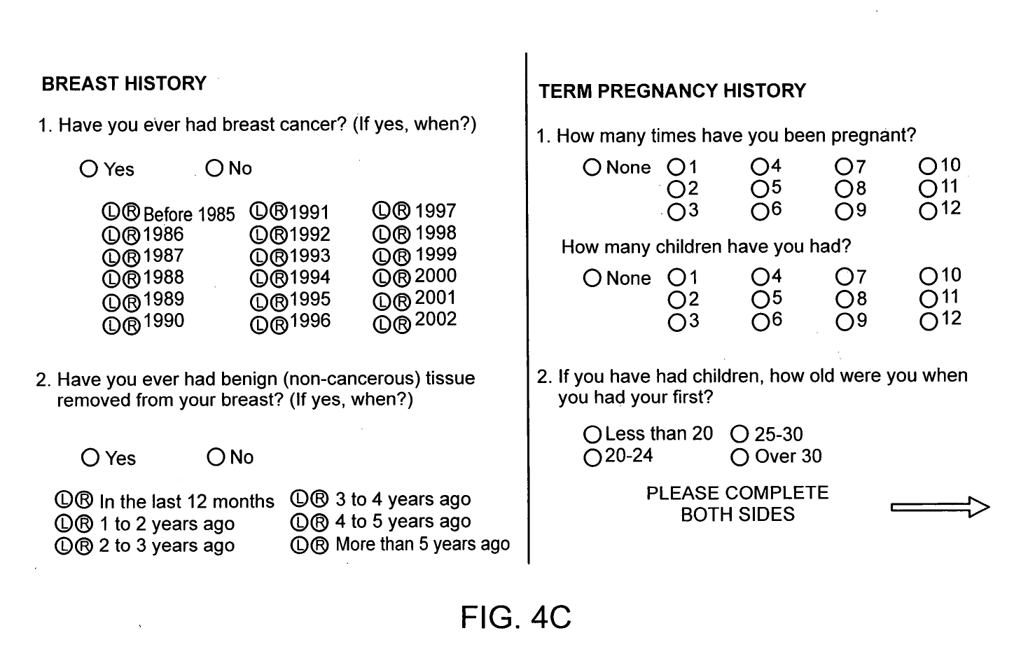

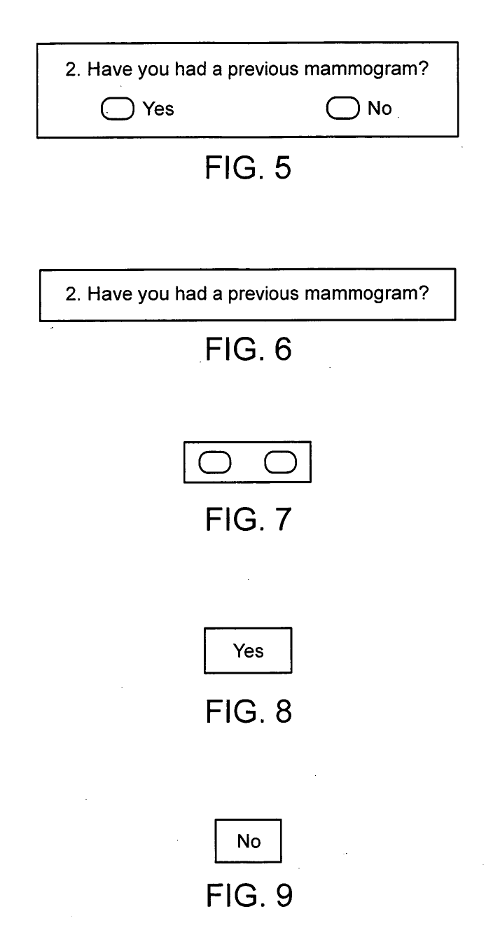

An example Meta-Specification 40 will now be described in detail, such as might be done for one question in an exemplary Breast Health Questionnaire form 10 as shown in FIG. 4. Let us consider how the second question asked in this specific would be encoded. The question appears visually, as shown in FIG. 5, as a question asking whether the patent has had a previous mammogram.

As a first step one needs to identify the different elements that compose this question. Here, one can identify four elements:

1. The first element of this example is the text “2. Have you had a previous mammogram?” This is shown graphically in FIG. 6.

2. The second element of this example, shown in FIG. 7, is an Option Box used to represent the selection choices. Note that even though there are two circles in this element, we identify the Option Box as a single data-point, since the answer represents the value of ONE data point.

3. The third element of this example is the text “Yes”, shown in FIG. 8.

4. The fourth element of this example is the text “No”, shown in FIG. 9.

Next, we assign a unique identifier to each element. Note that a unique identifier is a string that can only be used to represent one single element within the application.

1. The first element of this question is thus the text “2. Have you had a previous mammogram?” (that is, the element shown in FIG. 6). We assign a unique identifier, e.g., “o2_1” to this element.

2. The second element of this question is the Option Box used to represent the selection choices for this question (FIG. 7). Let's assign the unique identifier as “o2_2” to the Option Box.

3. The third element of this question is the text “Yes” (FIG. 8). Let's assign the unique identifier as “o2_3” to this element.

4. The fourth element of this question is the text “No” (FIG. 9). Let's assign the unique identifier as “o2_4” to this element.

V. Example of Meta-Specification Encoding

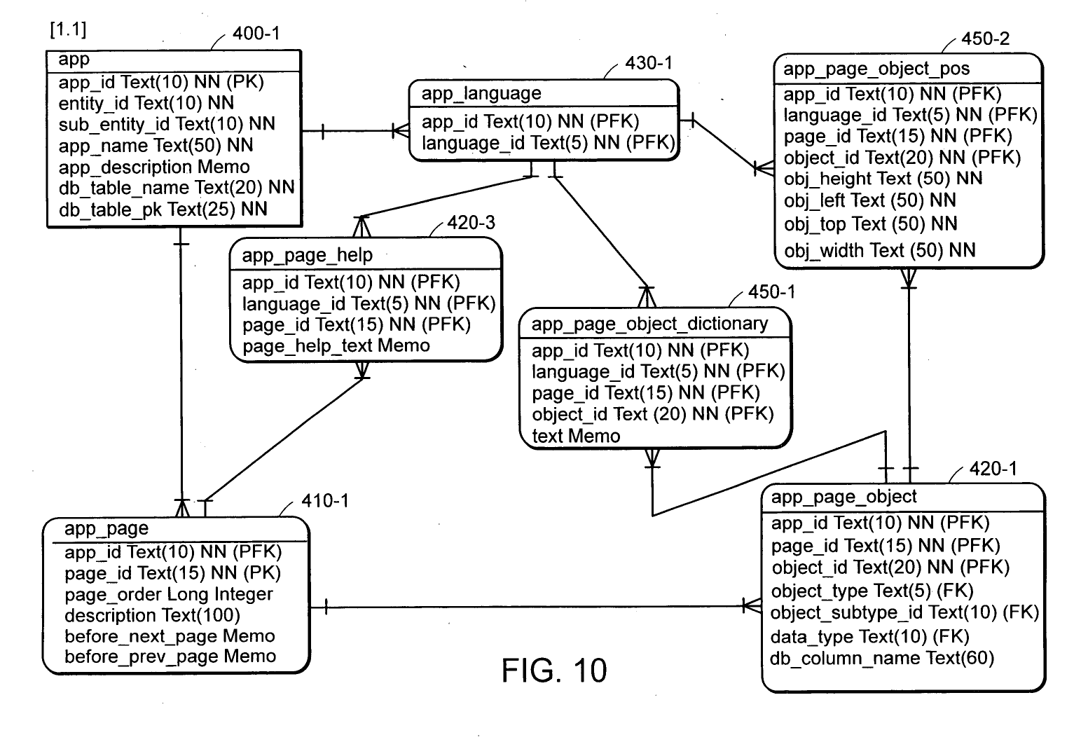

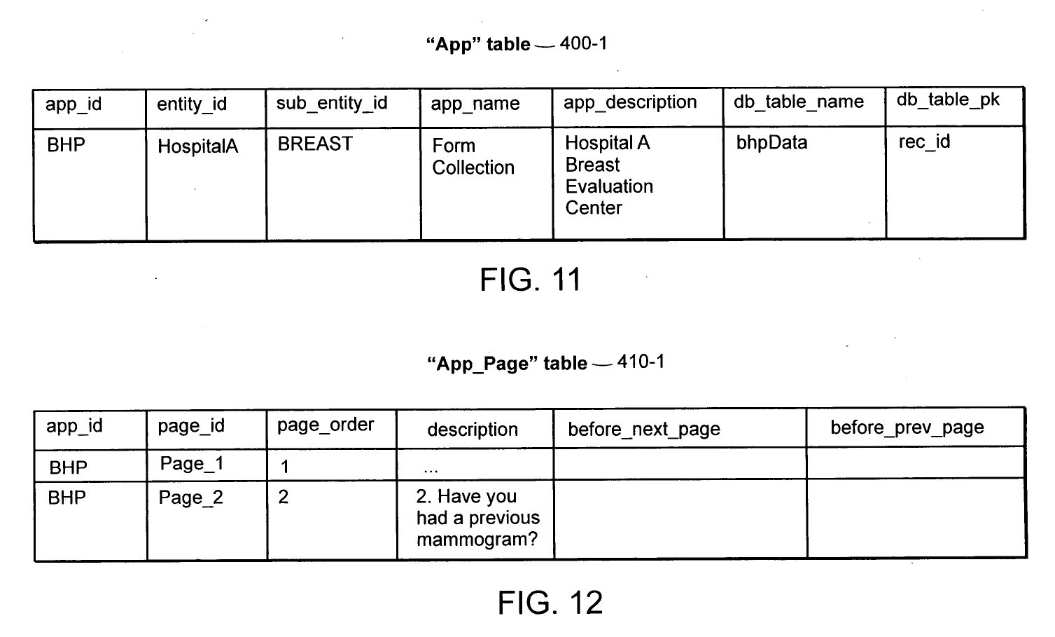

We now discuss how to write the Meta-Specification 40 for the above single question. As will become evident from the following discussion, the Meta-Specification 40 will eventually be developed as a hierarchical data structure shown in FIG. 10, that consists of Application level 400, Page level 410, Object level 420, Language level 430, and other specifications. FIG. 11 is a high-level depiction of the Meta-Specifications 40, and FIGS. 12-17 show each of its components in more detail. First, the Application level Meta-Specifications are determined. The first table populated is an “App” table 400-1, as shown in detail in FIG. 11. The elements of the App table 400-1 are as follows:

app_id This is a unique id that distinguishes every application.

entity_id Every application can be categorized by entity and sub entity. For example the entity can be Massachusetts General Hospital (“MGH”).

sub_entity_id The sub-entity can be a department, such as the Breast Health Department (“BREAST”).

app_name A short name that describes the application. This is usually the name of the form that was automated.

app_description This is a detailed textual description of the application.

db_table_name This is the name of the database table, where this particular application will store the information collected from the user (or the interview).

db_table_pk This is the name of the database field in the table db_table_name_which represents the primary key for the table.

The next table populated is the “App_Page” table 410-1. As shown in FIG. 12, this table includes:

app_id This is the unique id that distinguishes every application. (same id as app table). This tells us the ID for the application that we want to populate pages for.

page_id This is a unique id that distinguishes every page within the application.

page_order This is an integer that is used to dictate the sequence (order) in which the pages of the application are displayed.

Description This is a textual description of the question, used for identification purposes. (Similar to a comment field for this entry).

before_next_page This field holds the branching logic code that is to be executed when we move forward from one question to the subsequent question.

before_prev_page This field holds the branching logic code that is to be executed when we move backwards from one question to the prior question. Branching logic code will be described in more detail below.

The next table needed is the “App_Language” table 430-1. As shown in FIG. 13 this table includes

app_id This is the unique id that distinguishes every application. (same id as app table). This tells us the ID for the application that we want to add languages for.

language_id This is a unique id that distinguishes every language within the application.

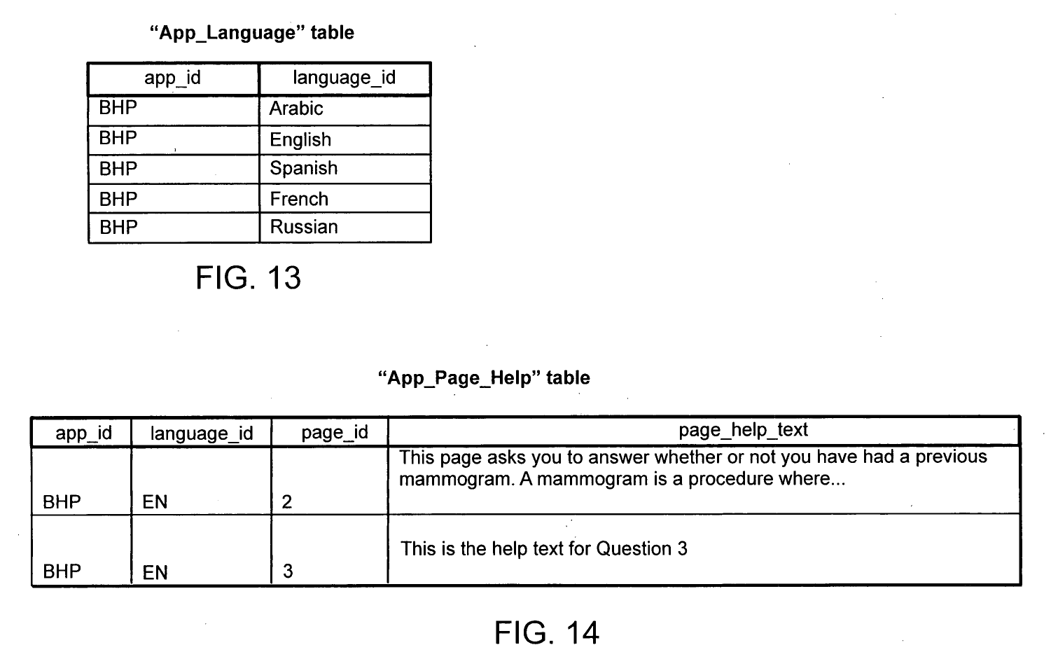

The next table that we need to populate is the “App_Page_Help” table 420-3, as in FIG. 14:

app_id This is the unique id that distinguishes every application. (same id as app table). This tells us the ID for the application that we want to populate help pages for.

language_id This is a unique id that distinguishes every language within the application. This tells us the ID of the language in which we will add help text for this page.

page_id This is an integer that is used to dictate the sequence (order) in which the pages of the application are displayed. This tells us the ID of the page that we will add help text for.

page_help_text This is a textual description of the question, used for identification purposes. (similar to a comment field for this entry).

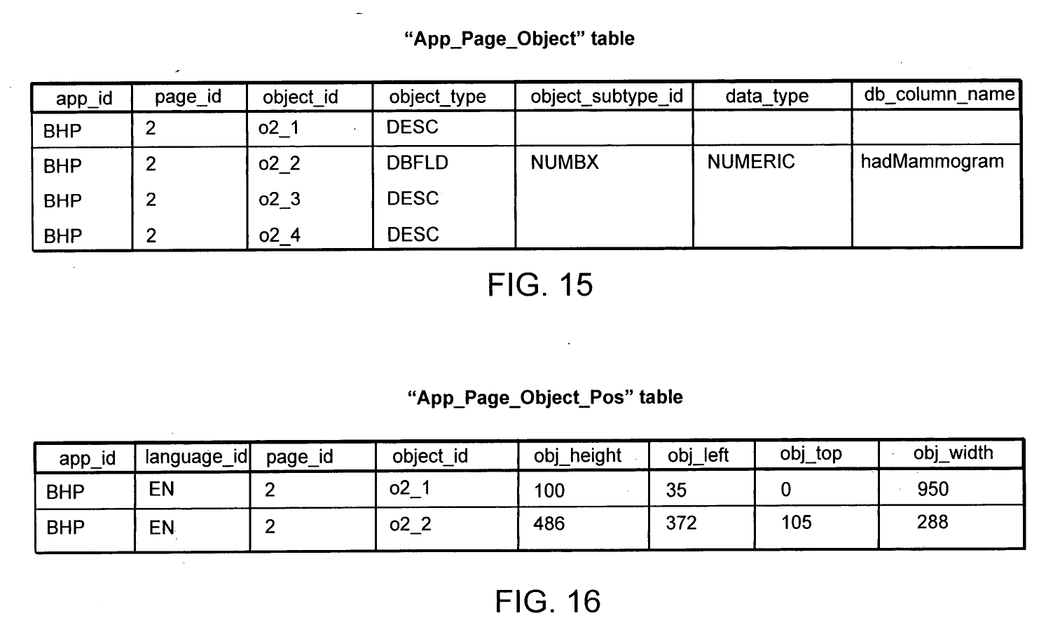

The next table we need to populate is the “App_page_object” table 420-1, as shown in FIG. 15

app_id This is a unique id that distinguishes every application. This tells us the ID for the application that we want to describe the page layout for.

page_id This is a unique id that distinguishes every page within the application. This tells us the ID of the page, within the app_id described above that we want to describe the page layout for.

object_id This is a unique id that distinguishes every object within the page. This tells us the ID of the object, within the page_id described above that we want to include in the page layout.

object_type This tells us the type of the object represented by the above object_id. The different types an object can take are:

| | |
|---|---|
| DBFLD | Database Field (Data point within the page) |
| DESC | Description Field (Textual entry within the page) |

object_subtype_id If an object has an object_type which is DBFLD, then it must have an associated sub_type. This field describes the type of visual control, that will be used to collect the information from the questionnaire for the DBFLD. The different types of visual components available for subtypes are:

| | |
|---|---|
| CHK | Multiple Selection Checkbox |
| DATE | Used to collect a Date |
| DRAW | Used to collect freehand (signaturecollection) |
| HGHT | Used to collect height |
| NUMBX | Number Selection Control |
| RADIO | Single Selection Checkbox |
| TIME | Used to collect a Time |
| TXTBX | Textbox used to collect textual entries (typed) |
| | (many others are possible) |

data_type If an object has an object_type which is DBFLD, then it must have an associated data_type. This field describes the type of data to be collected by this control. This field can be numeric or string (text).

db_column_name If an object has an object_type which is DBFLD, then it must have an associated db_column_name. This field describes the name of the column where the data collected from this DBFLD will reside. This column must exist in the database described by the entry db_table_name in the table called “App”. Responses are encoded as a data field that does not vary as the application language. That is, regardless of the language specified, the data field will have the same encoding.

Another table captured in the “App_page_object_pos” table 450-2 shown in detail in FIG. 16. This is not strictly a Page level 410 or Object level 420 element, but an intersection 450 between them.

app_id This is a unique id that distinguishes every application. This tells us the ID for the application that we want to describe the object layout for.

language_id This is a unique id that distinguishes every language within the application. This tells us the ID of the language in which we will describe the object layout for.

page_id This is a unique id that distinguishes every page within the application. This tells us the ID of the page, within the app_id described above that we want to describe the object layout for.

object_id This is a unique id that distinguishes every object within the page. This tells us the ID of the object, within the page_id described above that we want to describe the layout for.

obj_height This is an integer that specifies the height in pixels for this object.

obj_left This is an integer that specifies the left position in pixels for this object.

obj_top This is an integer that specifies the top position in pixels for this object.

obj_width This is an integer that specifies the width in pixels for this object.

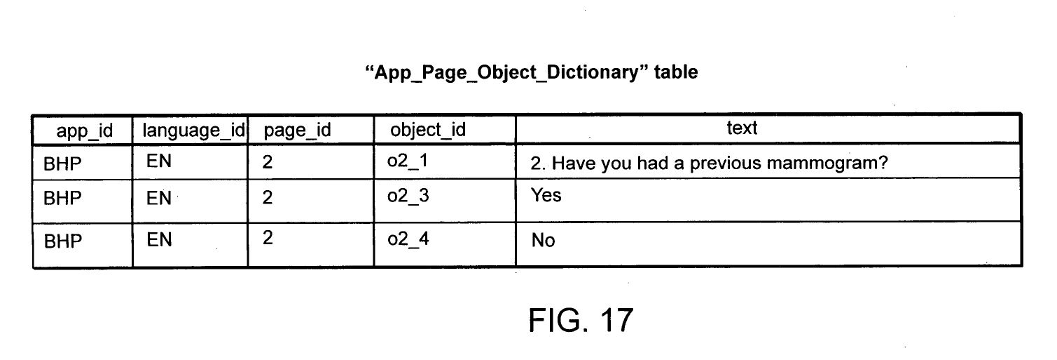

The last table needed is the “App_page_object_dictionary” table 450-1, another intersection object. Every entry in the table “App_page_object” table, whose object_type is equal to DESC (which means that it is a textual field), must have an entry in this table. FIG. 17 illustrates one example of this table.

app_id This is a unique id that distinguishes every application. This tells us the ID for the application that we want to describe the object layout for.

language_id This is a unique id that distinguishes every language within the application. This tells us the ID of the language in which we will describe the object layout for.

page_id This is a unique id that distinguishes every page within the application. This tells us the ID of the page, within the app id described above that we want to describe the object layout for.

object_id This is a unique id that distinguishes every object within the page. This tells us the ID of the object, within the page_id described above that we want to describe the layout for.

text This is the text that will be displayed, in the language described by language_id, (with the positioning described in the table app_object_pos) as the visual representation of this object.

Page Branching

In the preferred embodiment, page branching logic code, that specifies transitions between pages in the user interface, resides in two fields in the “App_Page” table 410-1. Referring to FIG. 12, the “App_Page” table 400-1, this is captured in the following entries:

before_next page This field holds the branching logic code that is to be executed when we move forward from one page to the subsequent page.

before_prev_page This field holds the branching logic code that is to be executed when we move backwards from one page to the prior page.

Through the code in these database fields we can alter the structure of the default page order. The default page order is set to present each page, one at a time, sequentially ordered by “page_order”. However, if based on the answer to a particular question (on page X), we wish to “branch forward” to page X+Y (instead of page X+1) then we can achieve this through the code stored in the before_next_page field.

The code in the fields: before_next_page, and before prev page can be entered in a scripting language such as VbScript, JavaScript or Python, and includes the standard if-then logic operators. As the name suggests, the code in these fields is executed before advancing (or retracting) to the next (or the previous) page.

The syntax for altering the branching structure in our application is the following:

if getPageObjectValue([PAGE_ID], [OBJECT_ID])=[VALUE] then

nextPageToBranch=[PAGE_ORDER]end if

As an example, the following code executes before branching FROM PAGE 2, (which would otherwise branch TO PAGE 3 under default behavior). In this example, if the value given by the user is “N” then instead of branching TO PAGE 3, we alter the branching structure and branch to page 5.

if getPageObjectValue(“2”,“o2_2”)=“N” then nextPageToBranch=“5”

end if

VI. Metadata Reader 100 Algorithm

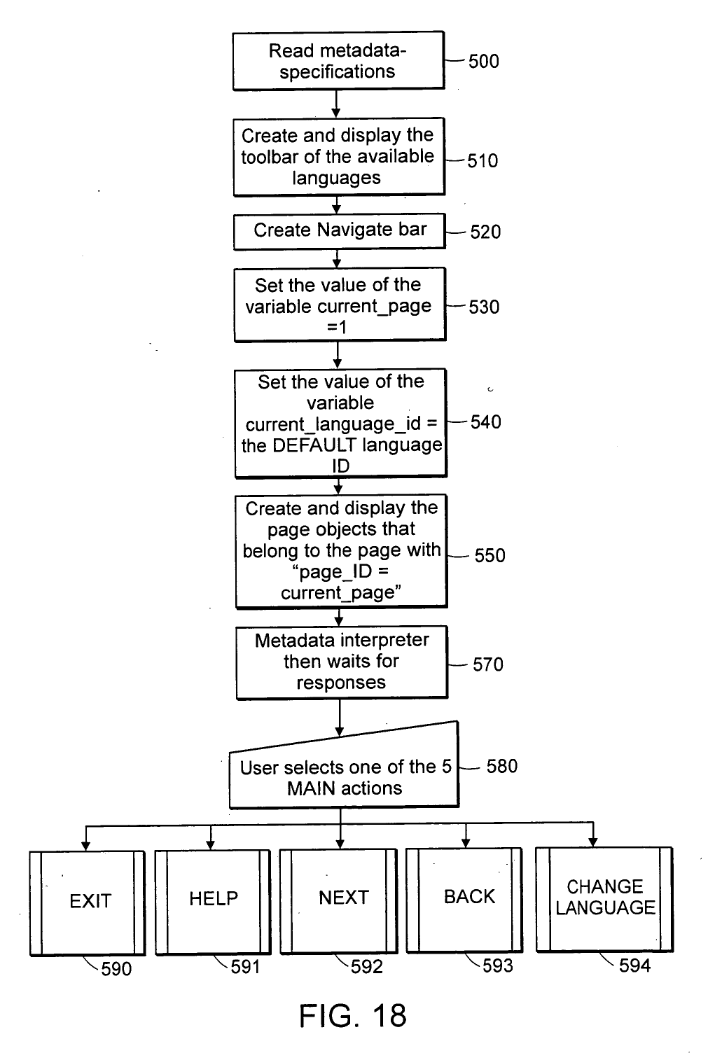

FIGS. 18, 19A, 19B, 20 and 21 are detailed flow diagrams for the Metadata Reader 100 (also called the Interpreter 100 herein).

The functions generator includes populating the visual layout and responding to user feedbacks.

Populating Visual Layout

As a first step 500 in this function, all of the aforementioned Metadata-Specifications 40 are read for a specific application, by specifying an app_id, from the tables in the database 50, into internal (memory) data structures. This begins the process of populating the visual layout for this application.

Next, the Interpreter 100 creates and displays a toolbar of the available languages for the given application in step 510. This toolbar is derived from the data in “App_language.language_id”

3. In step 520, the Interpreter 100 creates and displays the NAVIGATION toolbar for the given application. This toolbar allows for navigation between the pages, and has entries for: EXIT, HELP, BACK, NEXT. The navigation toolbar is simply a set of objects described in the metadata.

4. Set the value of the variable current_Page=1 in step 530.

5. In step 540, we set the value of the variable current_language_id=the DEFAULT language ID. (Can be English or another language).

6. Next, in step 550, the Interpreter 100 creates and displays the page objects that belong to the page with “page_ID=current_page”. These objects are displayed according to their text, and positioning for current_language_id.

Responding to User Feedback

1. Once the metadata-specifications have been read, and the page with “page_ID=current_page” has been populated for the current_language_id, the Metadata interpreter then waits for responses (feedback) from the user, in step 570. There are five MAIN actions that can occur at this stage (step 580):

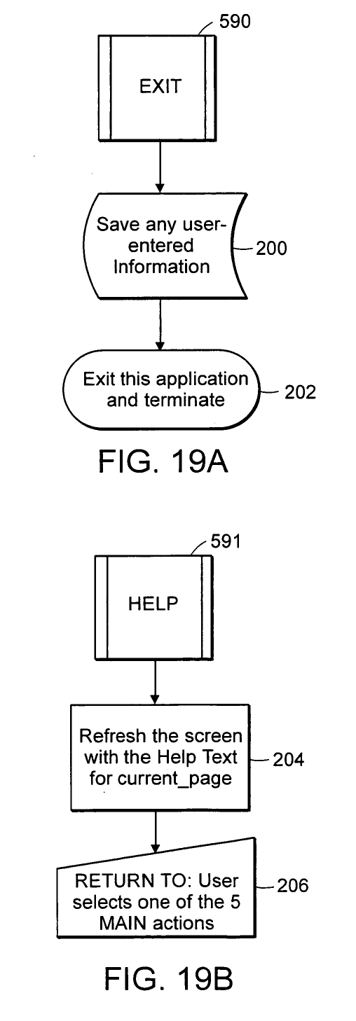

2. If the User clicks “EXIT” (step 590), then the Metadata Interpreter saves any user-entered information (step 700), exits this application (step 702) and terminates (see FIG. 19A).

3. If the User clicks “HELP” (step 591) (FIG. 19B), then the Metadata Interpreter refreshes the screen with the Help Text for the current page that it is displaying (step 704). This text is derived from the data in “App_page_help”. Then there is a return to the main action select step 580.

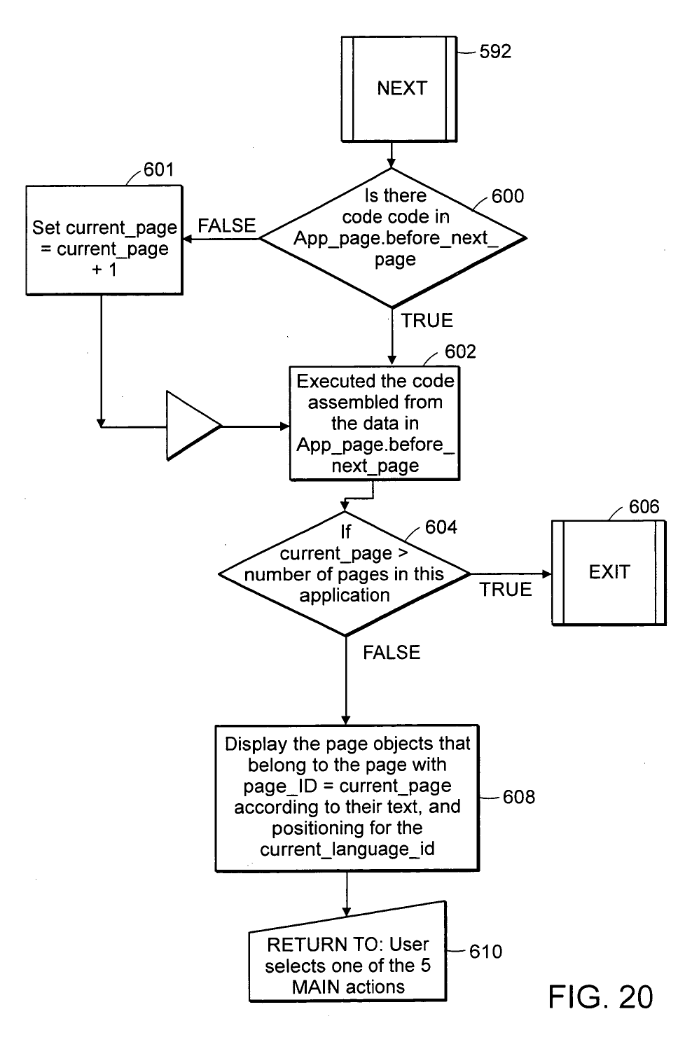

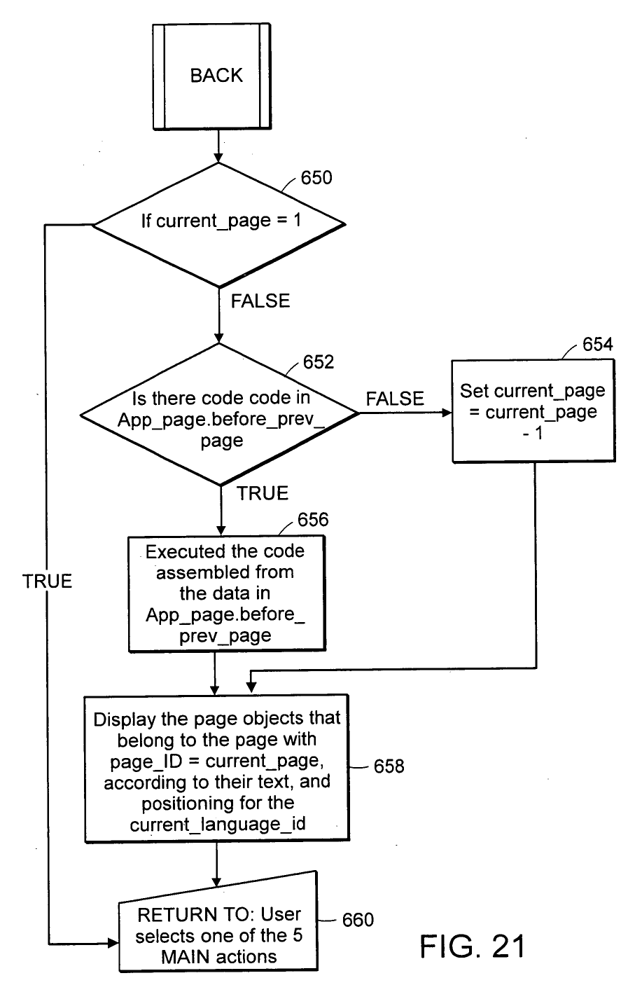

4. If the User clicks “NEXT” (step 592), then the following occurs (see FIG. 20)

a. Test to see if there is any code in the App_page_before next page block. (step 600) if so, the code assembled from the data in “App_page.before_next_page” is executed (step 602). This code may (or may not) alter the value of current_page.

b. If there is no code assembled from the data in “App_page.before_next_page” for this pageID then, set current_page=current_page+1 (step 601).

c. If current_page>number of pages in this application (step 604), then the Metadata Interpreter 100 saves any user-entered information, exits this application (step 606) and terminates.

d. If current_page<=number of pages in this application, then the Metadata Interpreter display the page objects that belong to the page with “page_ID=current_page” (step 608). The Interpreter displays these objects according to their text, and positioning for the current_language_id, prior to returning (step 610).

4. If the User clicks “BACK” (step 593), then the following occurs as shown in FIG. 21:

a. If current_page=1, then the Metadata Interpreter 100 ignores this request (step 650), since it is already displaying the first page in the application.

b. Otherwise, if present (step 652) the code assembled from the data in App_page.before_prev_page” is executed (step 656). This code may (or may not) alter the value of current_page.

c. If there is no code assembled from the data in “App_page.before_prev_page” for this page_D then, set current_page=current_page—1 (step 654).

d. Then the Metadata Interpreter 100 displays the page objects (step 658) that belong to the page with “page_ID=current_page”. The Interpreter displays these objects according to their text, and positioning for the current_language_id, prior to returning (step 660).

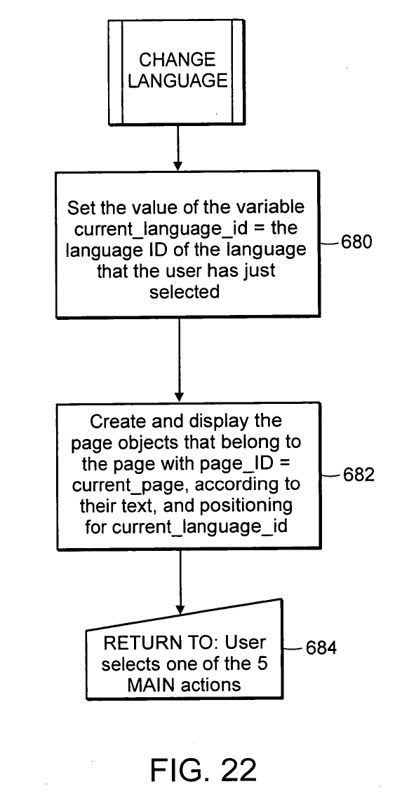

5. If the User clicks on the LANGUAGE TOOLBAR (step 594), in order to select one of the available languages for this application, then the following occurs (see FIG. 22):

a. Set the value of the variable current_language_id=the language ID of the language that the user has just selected (step 680).

b. Next, the Interpreter creates and displays the page objects that belong to the page with “page_ID=current_page ” (step 682). The page is refreshed and these objects are displayed according to their text, and positioning for current_language_id, prior to returning (step 684).

In closing, it can be appreciated that the invention has several benefits, including:

Reduces costly paper handling and manual routing, since paper based forms, costly to print, store, distribute, mail, and process, are replaced with automated form processing, ensuring there is no disconnect from the form and the business processes required for that form;

tracking and auditing, with instant access to current and prior activity, including completed forms and processes;

Automatic form pre-population from external database or application;

Pre/post processing scripts before form display and after form submission for custom business logic during form validation and processing;

Business logic at the form presentation layer, allowing form fields or sections to behave independent of the written language; and

All form data collected by users are stored in industry standard SQL or XML formats, etc.

While this invention has been particularly shown and described with references to preferred embodiments thereof, it will be understood by those skilled in the art that various changes in form and details may be made therein without departing from the scope of the invention encompassed by the appended claims.

What is claimed is:

1. A method for a multi-lingual user interface comprising:
defining a meta specification for the user interface as one or more database entries, wherein the meta specification comprises at least a language specifier and a page specification; and
defining a page specification that determines a layout of visual pages of the user interface, visual objects within each visual page, and branching logic for transitions between visual pages.

2. A method as in claim 1 wherein the meta specification is defined as a database object.

3. A method as in claim 1 wherein the visual objects specify attributes for text to be rendered on the visual page.

4. A method as in claim 3 wherein the attributes for the text are one of text size or text position that depend on the language specifier.

5. A method as in claim 1 additionally comprising:
displaying at least one page by dynamically interpreting the meta specification.

6. A method as in claim 1 additionally comprising:
storing user responses as database entries that are independent of the language specifier.

7. A method as in claim 6 wherein the meta specification further includes a designator for how to store encoded user responses.

8. A method as in claim 1 wherein the page specification includes intersection objects.

9. A method as in claim 1 wherein the visual objects include graphical objects.
